(19) United States
(12) Patent Application Publication
(10) Pub. No.: US 2010/0183417 A1
(43) Pub. Date: Jul. 22, 2010

(54) COUPLING FOR MACHINE TOOLS

(75) Inventor: Dietmar Martin, Braz (AT)

Correspondence Address: MORRISS OBRYANT COMPAGNI, P.C., 734 EAST 200 SOUTH, SALT LAKE CITY, UT, 84102, US

(73) Assignee: Josef Martin GmbH & Co KG, Braz (AT)

(21) Appl. No.: 12/664,645

(22) PCT Filed: May 30, 2008
(86) PCT No.: PCT/AT08/00187

§ 371 Date: Dec. 14, 2009

(30) Foreign Application Priority Data
Jun. 13, 2007 (AT) 922/2007

(51) Int. Cl. E02F 3/96; E02F 9/00; E02F 3/36; F16B 1/00

(52) U.S. Cl. 414/723; 403/316

(57) ABSTRACT

Disclosed is a coupling for machine tools, comprising a first main coupling part (1) and at least one additional main coupling part (2) for mechanically fastening an attachment (4) to the machine tool. A first power coupling part (5) is provided on the first main coupling part (1) and at least one other power coupling part (6) is provided on the additional main coupling part (2) in order to supply power to the attachment (4) or the machine tool. Furthermore, an actuator (7) which is used for actuating a locking mechanism (8) that interlocks the two main coupling parts (1, 2) is disposed on one of the main coupling parts (1, 2). A connecting device (9) is provided for automatically connecting the power coupling parts (5, 6). Said connecting device (9) for the power coupling parts (5, 6) is fitted with at least one spline (20) which can be preferably moved in a linear manner and slides the power coupling parts (5, 6) onto one another for connecting purposes by means of a wedging surface (21). The power coupling parts (5, 6) are each equipped with at least one power coupling plate (16, 17), on each of which female and male power coupling elements (18, 19) are arranged that can be engaged with one another. The wedging surface (21) of the spline (20) acts upon a wedge-shaped guiding surface (22) of the power coupling plate (16) of the first power coupling part (5) and moves the power coupling plate (16) relative to the first main coupling part (1).

### CROSS-REFERENCE TO RELATED APPLICATIONS

This application claims priority to PCT/AT2008/000187 filed on May 30, 2008, and A 922/2007 filed on Jun. 13, 2007, the entirety of each of which are incorporated by this reference.

### BACKGROUND

1. Field of the Invention

The present invention relates to a coupling for work machines, also referred to as machine tools, having a first main coupling part and at least one additional main coupling part for mechanically fastening an attachment to the work machine, where a first power coupling part is provided on the first main coupling part, and at least one additional power coupling part is provided on the additional main coupling part, to supply power to the attachment or to the work machine, and an actuator is disposed on one of the main coupling parts, which is provided for activating a locking device for locking the two main coupling parts together with one another, where a connecting device is provided for automatically connecting the power coupling parts, and the connecting device for the power coupling parts has at least one pusher wedge that can be moved in linear manner, which pushes the power coupling parts onto one another with a wedge surface, to connect them, where the power coupling parts have at least one power coupling plate, in each instance, where female and male power coupling elements that can be brought into engagement with one another are disposed on the power coupling plates, in each instance. Furthermore, the invention also relates to a work machine having a coupling according to the invention.

2. State of the Art

Couplings of this type are particularly used in heavy work machines, such as backhoes, caterpillars, or agricultural equipment, to which attachments such as backhoe shovels or scoops, hammers, shaker plates, and the like must be fastened, where actuators that must be supplied with power are provided on the attachments. Frequently, this power supply involves hydraulic lines. Sometimes, however, other types of power, such as electrical cables or pneumatic lines, must also be connected by means of the power coupling parts. In most cases, the attachments are connected with a movable arm of the work machine.

In the state of the art, it is known to bring the two main coupling parts into a locking position by way of a pivoting movement, in which position a locking device is then brought into the closed position, by way of an actuator that is affixed to one of the main coupling parts, thereby completing the mechanical connection of the main coupling parts and thus of the attachment to the work machine. In order not to have to subsequently connect the power coupling parts with one another manually, it is also known to provide connecting devices that allow automatically connecting the power coupling parts, in other words not manually. In the state of the art, these connecting devices are either implemented with separate actuators or are automatically brought into contact when the main coupling parts are joined together by means of the arm of the work machine.

DE 10 2004 014 824 A1 shows a coupling of this type, in which a power coupling plate is rigidly fastened to the first main coupling part, and the other power coupling plate is held on the second main coupling part so that it can pivot, with deformation of rubber springs. In the case of the rubber springs, there is the risk that these will lose their elasticity as the result of aging, and that the power coupling elements will then no longer close reliably. In this coupling, the locking device and the connecting device are configured in one piece, in the form of a locking journal.

DE 601 02 711 T2 shows a mechanically complicated solution of the type stated, which also requires a lot of space, having wedge-shaped motion link guides in which pins are guided.

### SUMMARY OF THE INVENTION

It is the task of the invention to propose a coupling of the type stated, designed in space-saving manner, with which a reliable connection between the power coupling parts is permanently guaranteed.

This is achieved, according to the invention, in that the wedge surface of the pusher wedge acts on a guide surface of the power coupling plate of the first power coupling part, which surface is constructed in wedge shape, and displaces the power coupling plate relative to the first main coupling part.

This results in a particularly reliable type of coupling, which can be implemented in space-saving manner.

In this connection, it is advantageously provided that the connecting device for automatically connecting the power coupling parts be connected with the locking device, to the effect that the actuator of the locking device additionally, or also simultaneously, activates the connecting device, and thus interlocking the main coupling parts and connecting the power coupling parts can be carried out by one actuator, in one work step. This results in a simple design with which the power coupling parts can be securely and reliably coupled, so that leakage is avoided, particularly in the case of hydraulic or pneumatic power coupling parts.

Illustrated embodiments provide that before the locking device is activated, the main coupling parts are pivoted toward one another into a locking position, about a pivoting axis, where the main coupling parts can be locked together with one another in the locking position, by means of the locking device.

This can be achieved, for example, in that one of the main coupling parts has at least one bolt, and the other of the main coupling parts has an accommodation claw that corresponds to the bolt, where the main coupling parts can be pivoted toward one another into the locking position, when the bolt is mounted in the accommodation claw.

The locking device can have a locking journal, for example, that can be moved by the actuator in linear manner, which journal is disposed on one of the main coupling parts and can be brought into engagement with a locking element disposed on the other main coupling part. This involves a shape-fit engagement that ensures precise alignment of the main coupling parts and thus also of the power coupling parts. For example, a locking accommodation into which the locking journals can be introduced can be provided as the locking element. However, locking elements such as additional bolts, for example, are also possible, around which or behind which the locking journal engages, as with shape fit. The actuator for activating the locking device and the connecting device can be configured hydraulically and/or pneumatically and/or electrically. In order to assure precise and leakage-free connecting of the power coupling parts, it is advantageous to provide a guide that ensures that the power coupling parts are mounted so that they can be moved toward one another in linear manner.

### BRIEF DESCRIPTION OF THE DRAWINGS

Other characteristics and details of the invention will be explained as examples using an exemplary embodiment shown in the figures. These show:

FIG. 1 is an exemplary embodiment before the two main coupling parts have been pivoted toward one another;

FIG. 2 is an exemplary embodiment in the locking position before activation of the actuator;

FIG. 3 is an exemplary embodiment in the final, locked position; and

FIG. 4 is a section through the pusher wedge and the power coupling plate along the section line AA.

### DETAILED DESCRIPTION OF THE ILLUSTRATED EMBODIMENTS

The embodiment variant shown in the figures shows the example of a coupling having a first main coupling part 1 and an additional coupling part 2 for fastening the attachment 4, configured here in the form of a backhoe scoop, to the hydraulic arm 3 of the work machine. In this connection, the two main coupling parts 1, 2 can be can be attached to the work machine and to the attachment 4 in fixed manner, for example by means of welding them on. However, it is more advantageous if the main coupling parts 1 and 2 are fastened to the attachment 4 and/or to the work machine, i.e. its arm 3, in replaceable manner, for example, by means of screwing them on.

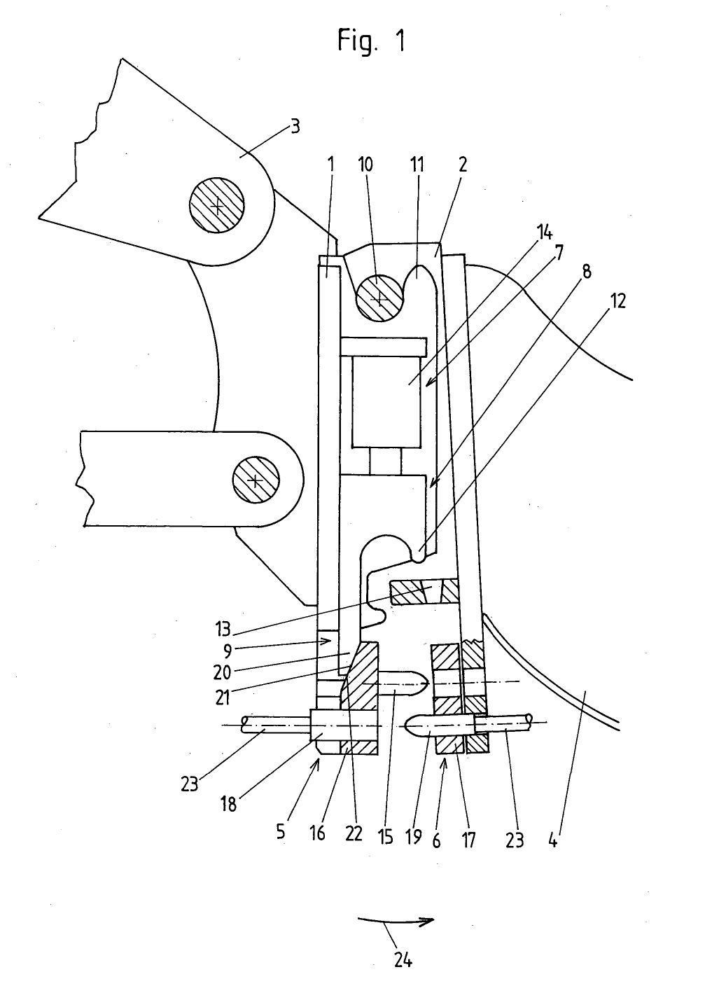

In the position shown in FIG. 1, the accommodation claw 11 disposed on the first main coupling part 1 here already engages behind the bolt 10 that is disposed on the additional main coupling part 2 here. This position can be reached, for one thing, in that the attachment 4 is laid into the accommodation claw 11 with its bolt 10. Particularly in the case of heavy attachments, however, the bolt 10 of the attachment 4 will generally have the accommodation claw 11 engage behind it, using the drive of the arm 3.

In the position shown in FIG. 1, neither the locking journal 12 and the locking accommodation 13 of the locking device 8 nor the power coupling part 5 and 6 are in engagement with one another.

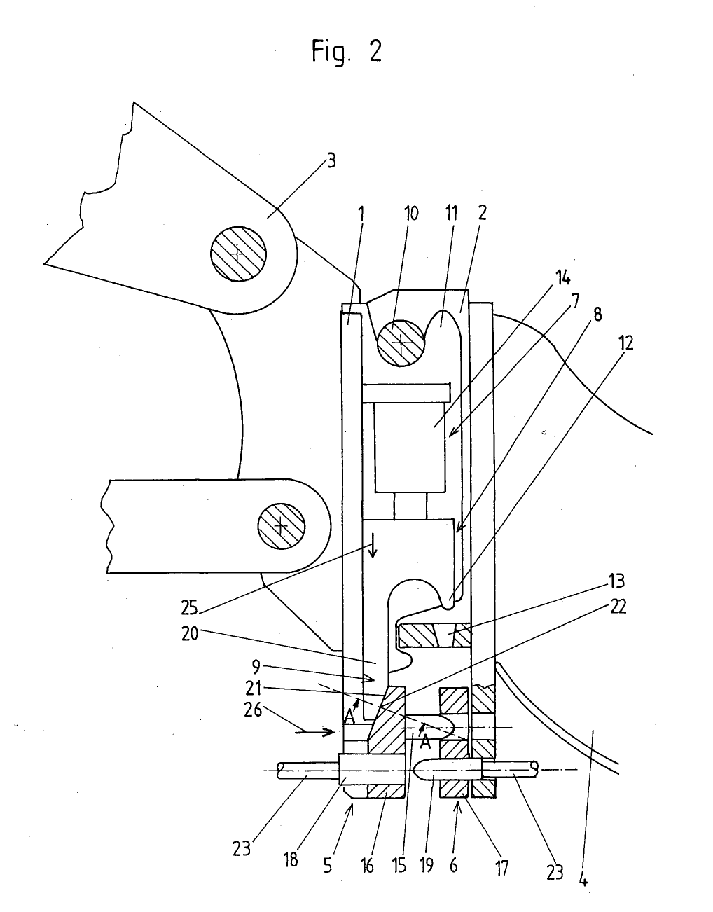

From the position shown in FIG. 1, in this exemplary embodiment, the two main coupling parts 1 and 2 are first pivoted in the direction 24, into the locking position shown in FIG. 2, where the bolt 10 serves as an axis of rotation. Even though this is an advantageous exemplary embodiment, it does not necessarily have to be provided for the invention that the two main coupling parts 1 and 2 must be brought into the locking position by means of a pivoting movement. If the accommodation claw 11 is structured accordingly, it can certainly also be provided that the first main coupling part 1 is pushed onto the additional main coupling part 2 of the accommodation device 4 in a linear movement, by means of the arm 3.

In the locking position shown in FIG. 2, it is now possible to bring the locking device 8 and the connecting device 9 into their locking positions, in each instance. Before this takes place, neither the power coupling parts 5 and 6 nor the locking journal 12 and the locking accommodation 13 are in engagement with one another. In order to now both undertake mechanical locking of the main coupling parts 1 and 2 with one another and connect the power coupling parts 5 and 6 with one another, it is now provided that the common actuator 7 activates both the locking device 8 and the connecting device 9. In the exemplary embodiment shown, the two devices perform a linear movement, in each instance. To the extent that this relates to the locking device 8, in this connection the locking journal 12 is pushed into the locking accommodation 13 in the direction 25. At the same time, the pusher wedge 20, which is compulsorily coupled with the locking journal 12 and the actuator 7—because it is fastened to them in fixed manner—is also displaced in the direction 25, thereby pushing its wedge surface 21 along the guide surface 22, which is correspondingly configured in wedge shape. This leads to the result that the power coupling plate 16 of the first power coupling part 5, which carries the guide surface 22, is pushed in the direction 26, toward the second energy coupling plate 17 rigidly disposed on the second main coupling part 6, in the exemplary embodiment shown. In the exemplary embodiment shown, the wedge surfaces 21, 22 are configured in such a manner that the movement directions 25 and 26 are oriented at a right angle relative to one another. However, this does not necessarily have to be provided in this way. Other angles between the movement directions 25 and 26 are also possible. Other exemplary embodiments are also possible, in which not purely linear movements but also rotational or linear and rotational movements must be carried out in order to interlock the main coupling parts 1 and 2 and the power coupling parts 5 and 6.

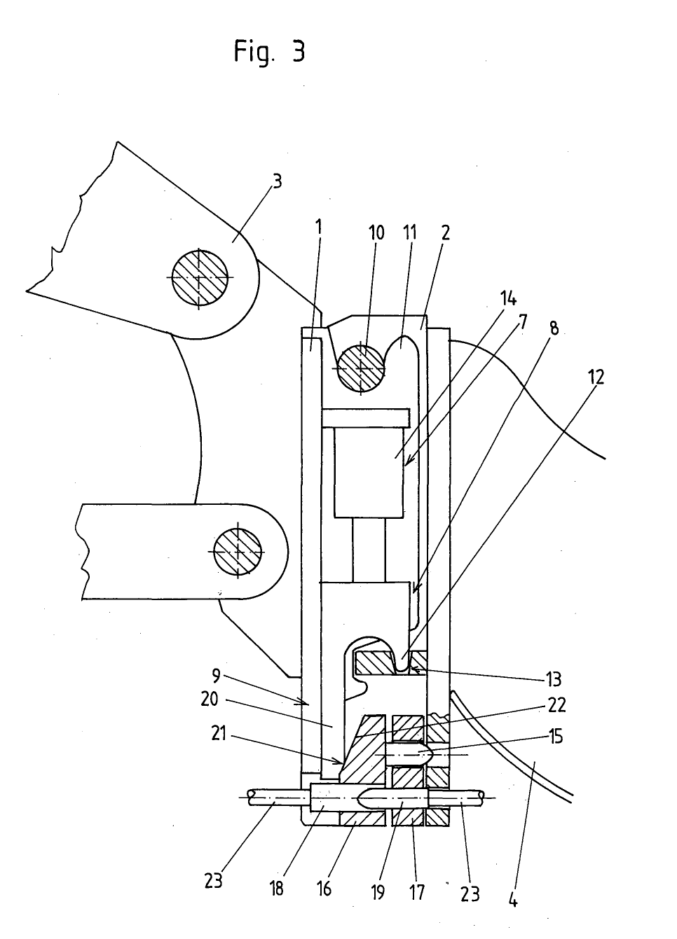

As can be derived from FIGS. 1 and 3, the locking journal 12 and the wedge surface 21 of the pusher wedge 20 are two separate components, which are spaced apart from one another, but, as implemented in the exemplary embodiment shown here, are advantageously structured to be compulsorily coupled. In the exemplary embodiment shown, this is achieved in that they are disposed in one piece on a common support 32, so that, as explained above, they can be displaced synchronously and parallel to one another, by the actuator 7, in the direction 25 and in the opposite direction. With the aim of the most compact construction possible, it is advantageous if the wedge surface 21 and the locking journal 12, as implemented in the exemplary embodiment shown, are spaced apart from one another in the direction of their common displacement 25. As shown in FIGS. 1 to 3, the pusher wedge 20, i.e. the edge surface 21, projects beyond the locking journal 12 in the direction 25. However, an opposite arrangement is also possible. To guide the power coupling plate 16 in the direction 26, rail-like guides or the like can be provided on the first main coupling part 1, in addition to the guide journal 15, which guides bring about a linear compulsory guidance of the power coupling plate 16 during its displacement relative to the first main coupling part 1 in the direction 26 and/or in the opposite direction. The second power coupling plate 17 can be disposed on the second main coupling part 2 in fixed manner.

In order to guarantee the purely linear movement of the power coupling parts 5 and 6, i.e. their power coupling plates 16 and 17, toward one another, in the example shown, a linear guide in the form of the guide journal 15 is provided. The latter ensures that the male power coupling element 19 penetrates precisely into the female power coupling element 18, so that a fluid-tight fit is produced, particularly in the case of hydraulic or pneumatic power coupling parts. The reference symbol 23 shows the hydraulic or pneumatic hoses to be connected, as an example. Instead, however, of course, electrical, optical, or other cables might have to be connected with one another. This does not change anything in the embodiment of the coupling according to the invention. The number of power coupling elements 18 and 19 to be connected with one another can also vary. Furthermore, the male and/or female power coupling elements 18, 19 can, of course, be disposed on the power coupling plate 16 or on the power coupling plate 17, in each instance. Here, as many different embodiments as desired are possible. The only thing that is important is that the male and female power coupling elements 18, 19 are disposed in such a manner that they can be brought into connection with one another by moving the power coupling plates 16 and 17 toward one another. It is advantageous, in any case, if the power coupling parts are structured in the form of plug-in connections, since these are particularly simple to connect.

In the exemplary embodiment shown, the actuator 7 is structured in the form of a hydraulic piston/cylinder unit 14. However, this does not have to be the case. The actuator 7 can also be driven pneumatically, electrically, or in some other manner, e.g. magnetically.

FIG. 3 shows the final, locked position, in which the locking journal 12 engages with shape fit into the locking accommodation 13 here, so that a play-free mechanical connection between the first main coupling part 1 and the additional main coupling part 2 is assured. In this position, the power coupling parts 5 and 6 are also coupled with one another, where the male power coupling elements 19 also rest, in fluid-tight manner, in the female power coupling elements 18, thereby producing the connection of the two power coupling parts 5 and 6.

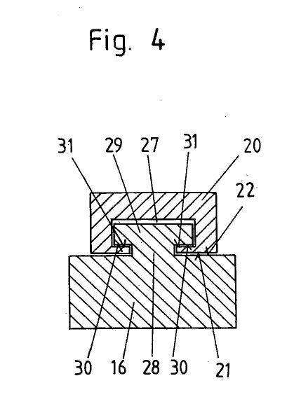

Unlocking and separating the power coupling parts 5 and 6 and the main coupling parts 1 and 2 takes place in the opposite sequence and can also be completely automated, in other words carried out without additional manual labor. For example, compulsory coupling of the power coupling plate 16 with the pusher wedge 20 can be provided for this purpose, making it possible for the power coupling plate 16 to be pulled off the power coupling plate 17 counter to the direction 26, with compulsory coupling, when the pusher wedge 20 is retracted counter to the direction 25. One of various possibilities of this compulsory coupling is shown in FIG. 4. This represents the pusher wedge 20 and the power coupling plate 16 in the section plane AA according to FIG. 2. The section plane AA stands orthogonally on the wedge surface 21 of the pusher wedge 20 and the guide surface 22 of the power coupling plate 16 in the representation shown. In this exemplary embodiment, a head 29 that engages into an undercut groove 27 is provided for compulsory coupling when the power coupling plate 16 is pulled off the power coupling plate 17. The shoulders 30 of this head 29 lie against slide surfaces 31 of the undercut groove 27. It is advantageous if the shoulders 30 and the slide surfaces 31 run parallel to the wedge surface 21 and to the guide surface 22, so that the head 29 can be displaced in the undercut groove 27 parallel to the wedge surface 21 and to the guide surface 22. In the exemplary embodiment shown, the undercut groove 27 is milled into the pusher wedge 20, and the head 29 is fastened to or formed on in one piece with the power coupling plate 16, by way of the neck 28. However, this does not have to be the case; it is just as well possible to provide a corresponding head with neck on the pusher wedge 20, and to dispose the undercut groove in the power coupling plate 16.

By means of this arrangement, it is guaranteed that the power coupling plate 16 is pulled off the power coupling plate 17, by means of the interaction of the shoulder 30 and the slide surfaces 31, as soon as the pusher wedge 20 is retracted counter to the direction 25. This leads to separation of the female and male power coupling elements 18 and 19. As has already been explained, this is only one possibility for separating the power coupling elements 18 and 19. It is also possible, just as well, to separate the power coupling plates 16 and 17 from one another again by means of other measures. For this purpose, for example, pins driven hydraulically or electrically could be provided in one of the power coupling plates 16 or 17, which, when activated accordingly, push the power coupling plates 16 and 17 away from one another and thereby separate them.

In the exemplary embodiment shown, the actuator 7 is disposed on the first main coupling part 1, and thus on the arm 3 of the work machine. This is advantageous because generally, the power supply from the work machine is supplied by way of the arm 3. Nevertheless, the invention is not restricted to this variant. Instead, the question as to which of the components are now to be disposed on the attachment 4 and which on the arm 3 or the wok machine itself lies completely within the discretion of the person skilled in the art. Alternative arrangements can particularly become interesting if the power supply no longer takes place by way of the work machine but rather by way of another power source.

Fundamentally, the invention is not restricted to specific types of work machines or to specific attachments. In particular, however, use in heavy work machines, such as backhoes, caterpillars, or agricultural equipment, to which attachments such as backhoe shovels or scoops, grippers, hammers, shaker plates, and the like, are to be fastened, is provided for.

1. A coupling for work machines, comprising:
a first main coupling part and at least one second main coupling part for mechanically fastening an attachment to a work machine;
a first power coupling part provided on the first main coupling part, and at least one second power coupling part provided on the at least one second main coupling part, to supply power to the attachment or to the work machine;
an actuator disposed on one of the first or at least one second main coupling parts for activating a locking device for locking the first and at least one second main coupling parts together;
a connecting device for automatically connecting the first and at least one second power coupling parts having at least one pusher wedge that can be moved in linear manner, which pushes the first and at least one second power coupling parts onto one another with a wedge surface, to connect them, where the first and at least one second power coupling parts each have at least one power coupling plate;
female and male power coupling elements, each disposed on a respective one of the at least one power coupling plate of the first and at least one second power coupling parts, that can be brought into engagement with one another such that the wedge surface of the at least one pusher wedge acts on a guide surface of the power coupling plate of the first power coupling part and displaces the power coupling plate relative to the first main coupling part.

2. The coupling according to claim 1, wherein the connecting device can be activated by the actuator.

3. The coupling according to claim 1, wherein the first and at least one second main coupling parts can be pivoted toward one another into a locking position, about a pivoting axis, where the first and at least one second main coupling parts can be locked together in the locking position, by the locking device.

4. The coupling according to claim 3, wherein one of the first and at least one second main coupling parts has at least one bolt, and the other of the first and at least one second main coupling parts has an accommodation claw that corresponds to the bolt, where the first and at least one second main coupling parts can be pivoted toward one another into the locking position, when the bolt is mounted in the accommodation claw.

5. The coupling according to claim 1, wherein the locking device has a locking journal that can be moved by the actuator, in a linear manner, which journal is disposed on one of the first and at least one second main coupling parts and can be brought into shape-fit engagement with a locking element disposed on the other of the first and at least one second main coupling parts.

6. The coupling according to claim 5, wherein the locking element is a locking accommodation into which the locking journal can be introduced.

7. The coupling according to claim 1, wherein the actuator has at least one hydraulically or pneumatically activated piston/cylinder unit.

8. The coupling according to claim 1, wherein the actuator has an electrical drive.

9. The coupling according to claim 1, further comprising a guide for ensuring that the first and at least one second power coupling parts are mounted so that they can be moved toward one another in a linear manner.

10. The coupling according to claim 9, further comprising at least one guide journal which is conical in at least certain sections, for centering the first and at least one second power coupling parts with one another.

11. The coupling according to claim 1, wherein the first and at least one second power coupling parts have plug-in connections.

12. The coupling according to, wherein the first and at least one second power coupling parts provide at least one of electrical, pneumatic and hydraulic connections.

13. The coupling according to, wherein the first and at least one second main coupling parts are fastened to at least one of the attachment and the work machine in a replaceable manner.

14. A work machine having a coupling, comprising:
first and second main coupling parts for mechanically fastening an attachment to the work machine;
first and second power coupling parts on the first and second main coupling parts, respectively, for supplying power to at least one of the attachment and the work machine;
an actuator coupled to one of the first and second main coupling parts for activating a locking device to lock the first and second main coupling parts together;
a connecting device for automatically connecting the first and second power coupling parts having at least one pusher wedge that is linearly moveable and that pushes the first and second power coupling parts onto one another with a wedge surface, to connect the first and second power coupling parts, where the first and second power coupling parts each have a power coupling plate;
female and male power coupling elements, each disposed on the at least one power coupling plate of the first and second power coupling parts and engageable with one another, the wedge surface of the at least one pusher wedge acting as a guide surface for the power coupling plate of the first power coupling part and displaces the power coupling plate relative to the first main coupling part.

15. The work machine of claim 14, wherein the connecting device is activated by the actuator.

16. The work machine of claim 14, wherein the first and second main coupling parts can be pivoted toward one another into a locking position, about a pivoting axis, and where the first and second main coupling parts can be locked together in the locking position with the locking device.

17. The work machine of claim 16, wherein one of the first and second main coupling parts comprises at least one bolt and the other of the first and second main coupling parts comprises a claw that corresponds to the bolt, where the first and second main coupling parts can be pivoted toward one another into the locking position when the bolt is mounted in the claw.

18. The work machine of claim 14, wherein the locking device comprises a locking journal disposed on one of the first and second main coupling parts that is movable by the actuator and can be brought into engagement with a locking element disposed on the other of the first and second main coupling parts.

19. The work machine to claim 1, further comprising a guide for ensuring that the first and at least one second power coupling parts are mounted so that they can be moved toward one another in a linear manner.

20. The work machine of claim 19, further comprising at least one guide journal having a least one conical section for centering the first and second power coupling parts relative to each other.
